(19) United States
(12) Patent Application Publication
(10) Pub. No.: US 2023/0193049 A1
(43) Pub. Date: Jun. 22, 2023

(54) ANTI-CORROSIVE AND SOUND DAMPENING COATINGS

(71) Applicant: Polylastix Corporation, New Smyrna Beach, FL (US)

(72) Inventors: Leonard WARREN, New Smyrna Beach, FL (US); Mark WHEATLEY, Mooresville, NC (US)

(21) Appl. No.: 18/085,154

(22) Filed: Dec. 20, 2022

Related U.S. Application Data
(60) Provisional application No. 63/292,255, filed on Dec. 21, 2021.

(51) Int. Cl. C09D 5/08; C09D 167/04; C09D 7/61; C09D 7/63; C09D 7/65; C09D 7/20

(52) U.S. Cl. CPC C09D 5/08; C09D 167/04; C09D 7/61; C09D 7/63; C09D 7/65; C09D 7/20

(57) ABSTRACT

A coating composition for providing anti-corrosive, wear-resistance, and sound dampening properties to plastic and metallic substrates. The composition comprises at least one functionalized resin and at least one dry lubricant in a solvent comprising a ketone, and can further comprise at least one of a cross-linking agent, a cross-linking catalyst, a co-solvent, and a colorant. Some compositions comprise multiple ketones and/or multiple dry lubricants, and can be formulated and applied to a substrate without producing hydrogen gas. Substrates coated with the coating composition can include metal components, particularly springs, washers, and other elements, within the liftgate support struts in a van, SUV, or other hatchback vehicle.

### CROSS-REFERENCE TO RELATED APPLICATION

The present application claims the benefit of U.S. Provisional Application No. 63/292,255 filed on Dec. 21, 2021, the entirety of which is hereby incorporated by reference.

### FIELD OF THE INVENTION

This invention relates to the field of formulating and applying compositions to metal and plastic substrates.

### BACKGROUND OF THE INVENTION

Coating compositions for metal and plastic substrates are extensively used in industrial and commercial applications. Such coatings can provide a variety of benefits, including but not limited to: wear protection; corrosion prevention; aesthetic color, appearance, and texture; absorption or reflection of light; lubrication; and sound dampening. Non-limiting examples of such coatings are described in U.S. Pat. Nos. 5,840,827, 6,255,523, 7,172,809, 7,658,967, 8,003,715, 9,187,673, 9,206,377, 9,494,062, 10,196,539, 10,273,428, and 11,046,865, as well as U.S. Patent Publication No. 2012/0225991, all of the disclosures of which are incorporated by reference in their entireties.

The identity and composition of such coatings can be selected and tuned based on the desired properties to be provided to a particular substrate and/or application method. For example, a coating composition can be designed or selected based on its adherence to an intended surface or surfaces and its performance when applied to a single metal, or a variety of metals which may have different surface characteristics and levels of cleanliness. Coating compositions can be applied to a single, planar substrate which is subsequently formed into a desired shape (e.g. coil coating processes), or they can be applied to substrates that are pre-formed into their desired shapes prior to coating. Further, in some instances, coating compositions can be applied to a plurality of substrates simultaneously, based on the arrangement of the substrates and the application method.

Additionally, a series of coating compositions can be applied to a substrate to form a multi-component coating system. As a non-limiting example, a multi-component coating system can be utilized in order to provide combinatory and/or synergistic benefits that are not attainable by a single composition alone. In another non-limiting example, a first coating composition is applied simply to provide a base coating, upon which a second coating composition can be applied. In still another non-limiting example, a second coating composition can be applied atop a first coating composition to stabilize and/or protect the first coating composition from the environment external to the substrate surface.

One such non-limiting example of a metallic substrate that is currently coated with a multi-component coating system is a spring, which once coated, is assembled with other machine elements into a support strut, a pair of which facilitates the opening and closing of the rear hatch (also referred to interchangeably herein as a “tailgate” or “liftgate”) of a van, SUV, or hatchback vehicle. Such springs and support struts are described in U.S. Pat. Nos. 6,719,356, 7,070,226, 7,938,473, 9,945,168, and 10,266,027, as well as U.S. Patent Publication Nos. 2007/0001356 and 2019/0178328, all of the disclosures of which are incorporated by reference in their entireties. The multi-component coating systems applied to the support struts generally consist of an anti-corrosive coating as a base layer, and a flocked outer layer adhered to the base layer by an adhesive. The anti-corrosive layer can be applied to the spring either by dip-spinning or with an electrostatic spray, whereas the adhesive and flock are typically applied using a spray, and each of the component layers can be cured separately or together in situ within an oven.

In addition to being time- and labor-intensive, applying a multi-component coating system to the spring requires special measures for handling and hazardous waste removal. Aluminum pigment powders, which are commonly used in flocks, can be dangerous because they will readily react with water, including water vapors contained within the air, to form hydrogen gas, which is combustible and has been the cause of multiple pigment plant fires. To combat the formation of hydrogen gas, aluminum can be provided as a paste within an organic solvent such as mineral spirits. However, dispensing and storing aluminum within an organic solvent can lead to issues with compatibility with other solvents and make the pigments a source of volatile organic compounds (VOCs), which are subject to increased regulatory scrutiny, where they can be used at all.

Accordingly, formulators are often forced to choose between a combustible pigment powder and a waterborne aluminum pigment preparation. Although waterborne aluminum pigment preparations can be effective, they often require the chemical modification of the pigments' surface and/or the deposition of a highly crosslinked inorganic or organic polymer or resin layer onto the pigments. Treating aluminum pigments in this way is expensive, and, as the coating system containing the aluminum pigment wears over time, can still result in the release of enough hydrogen gas to damage the substrate, even if the quantity of hydrogen released is not explosive.

Therefore, a further need remains for improved and more convenient coating compositions for providing enhanced properties to plastic and metal substrates.

### SUMMARY OF THE INVENTION

The present invention provides a composition for coating both metal and non-metal substrates, as well as substrates coated with the composition.

The embodiments and features described herein provide compositions that can impart properties to the substrate that typically require multiple compositions, working in tandem, to achieve. Non-limiting examples of such benefits can include: sound dampening; corrosion resistance; wear resistance; abrasion resistance; lubrication; and safe application by electrostatic spraying, including combinations thereof. In some embodiments, the compositions of the present invention can be prepared without forming hydrogen gas. In some embodiments, the compositions of the present invention can be applied to a substrate without flocking.

An embodiment of the invention provides a coating composition, the coating composition comprising: (a) at least one ketone; (b) at least one functionalized resin; and (c) at least one dry lubricant.

In some embodiments thereof, the at least one ketone can be selected from the group consisting of methyl amyl ketone; methyl aryl ketone; methyl ethyl ketone; methyl isopropyl ketone; and methyl isobutyl ketone, including combinations thereof. One non-limiting example of a combination of two or more ketones is a combination of methyl ethyl ketone and methyl isopropyl ketone. In another non-limiting example, a composition can comprise methyl isopropyl ketone as the only ketone.

In any of the various embodiments herein and above, the at least one functionalized resin can comprise a water-borne resin and/or a solvent-borne resin, and is preferably a solvent-borne resin selected from the group consisting of polyketone, and hydroxyl functional polyester resins, including combinations thereof. In some embodiments, resins used within the compositions of the present invention can contain substantially no formaldehyde. In some embodiments, the coating composition comprises a hydroxyl functional polyester as the lone functionalized resin within the composition. In some embodiments, the hydroxyl functional polyester has an acid value of less than about 10, and preferably at least about 6 and up to about 8. In some embodiments, the hydroxyl functional polyester has a hydroxyl number (mg KOH/gram of polyester) of at least about 250, and up to about 300, preferably having a hydroxyl number of about 280.

In any of the various embodiments herein and above, the at least one dry lubricant can be an inorganic solid selected from the group consisting of graphite, molybdenum disulfide, boron nitride, tungsten carbide, and tungsten disulfide, including combinations thereof. In a further embodiment, the coating composition can comprise molybdenum disulfide alone or in combination with one or mom additional dry lubricants.

In any of the various embodiments herein and above, the coating composition can comprise: (i) a total mass of the at least one ketone of at least about 30% by weight, and up to about 50% by weight; (ii) at least about 10% by weight, and up to about 35% by weight, of a hydroxyl functional polyester; and (iii) a total mass of the at least one dry lubricant of at least about 6% by weight, and up to about 25% by weight, of the at least one dry lubricant. In some embodiments, the at least one dry lubricant comprises molybdenum disulfide, and the composition comprises at least about 6% by weight, and up to about 12% by weight, of molybdenum disulfide.

In any of the various embodiments described herein and above, the coating composition can comprise one or more components in addition to the at least one ketone; at least one functionalized resin; and at least one dry lubricant. As a non-limiting example, the coating composition can further comprise: a cross-linking agent, wherein the cross-linking agent is capable of cross-linking hydroxyl functional polyesters; and a chemical catalyst for enhancing the reactivity between the cross-linking agent and the hydroxyl functional polyester. In some embodiments, the cross-linking agent is a methylated melamine monomer, and the chemical catalyst is an amine-blocked para-toluene sulfonic acid. In some embodiments, the mass ratio of the cross-linking agent to the chemical catalyst is in a range from about 8:1 up to about 12:1, and is preferably about 10:1. In some embodiments, wherein the composition comprises at least about 1% by weight, and up to about 6% by weight, of the cross-linking agent, and at least about 0.1% by weight, and up to about 0.6% by weight, of the chemical catalyst.

In another non-limiting example, and in any of the various embodiments herein and above, the at least one dry lubricant further comprises at least one fluoropolymer. In some embodiments, the at least one fluoropolymer preferably comprises polytetrafluoroethylene (PTFE). In some embodiments, the coating composition comprises up to about 14% by weight of the PTFE.

In another non-limiting example, and in any of the various embodiments herein and above, the coating composition further comprises a co-solvent, the co-solvent selected from the group of short-chain alkyl alcohols and aromatic solvents consisting of: methanol, ethanol, propanol, isopropanol, benzene, toluene, xylene, and mesitylene, including all combinations and isomers thereof. In some embodiments, the co-solvent is selected from the group consisting of ethanol and xylene, including all combinations and isomers thereof. In some embodiments, the co-solvent is one or more of the isomers of xylene-ortho-xylene, meta-xylene, and/or para-xylene (hereinafter collectively referred to as “xylene”). In some embodiments, the coating composition comprises up to 25% of the co-solvent.

In another non-limiting example, and in any of the various embodiments herein and above, the coating composition further comprises one or more supplemental compounds to facilitate application of the coating composition to a metal substrate using an electrostatic spray. In some embodiments, the one or more supplemental compounds comprises xylene. In some embodiments, the one or more supplemental compounds can comprise: silver, zinc, or copper compounds; graphite; graphene; and carbon black.

In another non-limiting example, and in any of the various embodiments herein and above, the coating composition further comprises a colorant. In some embodiments, the coating composition comprises up to about 2% by weight of the colorant.

In any of the various embodiments herein and above, the coating composition can comprise: (a) at least about 9% by weight, and up to about 13% by weight, of methyl isopropyl ketone; (b) at least about 20% by weight, and up to about 25% by weight, of methyl ethyl ketone; (c) at least about 18% by weight, and up to about 32% by weight, of hydroxyl functional polyester; (d) at least about 6% by weight, and up to about 12% by weight, of molybdenum disulfide; (e) at least about 10% by weight, and up to about 14% by weight, of PTFE; (f) at least about 1% by weight, and up to about 6% by weight, of methylated melamine monomer; (g) at least about 0.1% by weight, and up to about 0.6% by weight, of amine-blocked para-toluene sulfonic acid; and (h) at least 20% by weight, and up to about 25% by weight, of the co-solvent. In some embodiments, the co-solvent comprises one or more solvents selected from the group consisting of ethanol, xylene, and combinations thereof. In some embodiments, the co-solvent is xylene. In some embodiments, the coating composition comprises up to about 2% by weight of a colorant.

In any of the various embodiments herein and above, the coating composition can comprise: (a) at least about 40% by weight, and up to about 45% by weight, of methyl isopropyl ketone; (b) at least about 18% by weight, and up to about 32% by weight, of hydroxyl functional polyester; (c) at least about 6% by weight, and up to about 12% by weight, of molybdenum disulfide; (d) at least about 10% by weight, and up to about 14% by weight, of PTFE; (e) at least about 1% by weight, and up to about 6% by weight, of methylated melamine monomer; (f) at least about 0.1% by weight, and up to about 0.6% by weight, of amine-blocked para-toluene sulfonic acid; and (g) up to about 5% by weight, of the co-solvent. In some embodiments, the co-solvent comprises one or more solvents selected from the group consisting of ethanol, xylene, and combinations thereof. In some embodiments, the co-solvent is xylene. In some embodiments, the coating composition comprises up to about 2% by weight of a colorant.

In any of the various embodiments herein and above, the coating composition can be combined with one or more additional compositions and applied to a substrate as a multi-component coating system. In some embodiments, any of the compositions described herein can be applied to a substrate as a single-component coating system. Unless indicated otherwise, any of the composition components or properties of coating compositions of the present invention that are described herein can apply to compositions comprised either within single-component or multi-component coating systems.

In any of the various embodiments herein and above, the coating composition can be formulated to coat any metallic or plastic substrate that can withstand reaction conditions associated with the curing of resin(s) within the coating composition in situ. In some embodiments, resins included within any of the compositions described herein cure at elevated temperatures, generally at temperatures that are at least 90° C. and more particularly at temperatures at or above 180° C.

In any of the various embodiments herein and above, the present invention provides coated substrates, typically metal or plastic substrates, having at least a portion of a surface coated with the coating composition described herein. In some embodiments, a metal substrate can comprise a steel alloy. In some embodiments, the metal substrate is a spring designed as a component within a support strut for the rear liftgate of a vehicle, particularly a van, SUV, or hatchback vehicle.

In any of the various embodiments herein and above, the present invention provides a method of producing a substrate having at least a portion of its surface coated with the coating compositions described herein.

In any of the various embodiments herein and above, the coating composition can be applied to the substrate by dip-spinning the substrate into the composition.

In any of the various embodiments herein and above, the coating composition can be applied to a metallic substrate by electrostatically spraying the composition onto the substrate.

### BRIEF DESCRIPTION OF THE FIGURES

FIG. 1 shows a perspective view of a motor vehicle having a lift gate controlled by a pair of exemplary prior art support struts.

FIG. 2 shows a cross-sectional view in side profile of an exemplary prior art support strut having a spring in an extended position.

### DETAILED DESCRIPTION OF THE INVENTION

### Definitions

Unless otherwise provided, the following terms herein have the meaning provided below.

Other than in any operating examples, or where otherwise indicated, all numbers expressing quantities of composition components, reaction conditions, and the like that are used in the specification and claims are understood as being modified in all instances by the term, “about”. Accordingly, the term “about” is used to describe approximations of numerical parameters set forth in the specification and claims that may vary depending upon the desired properties to be obtained by the present invention. At the very least, and not an attempt to limit the application of the doctrine of equivalents to the scope of the claims, each numerical parameter should at least be construed in light of the number of reported significant digits and by applying ordinary rounding techniques.

The terms “acid value” and “acid number” are interchangeably used to describe the amount of carboxylic acid groups in a polyester resin, and are typically expressed as milligrams of potassium hydroxide required to titrate a 1-gram sample of resin to a specified endpoint (mg KOH/polyester resin). Methods for determining acid values are well-known in the art, and are defined, for example, according to ISO 2114-2000 and ASTM D974-04 (“Standard Test Method for Acid and Base Number by Color-Indicator Titration”).

The term, “crosslinker” refers to a molecule capable of forming a covalent linkage between polymers or between two different regions of the same polymer.

The terms “curing”, “cure”, and “crosslinking” are used interchangeably to describe the process of setting polymers to form an irreversibly crosslinked network, a material that can no longer flow, be melted, or dissolved. Curing is typically induced under a specified reaction condition, non-limiting examples of which include heat and/or radiation, ultimately connecting polymer chains together through the formation of permanent covalent (crosslinked) bonds, resulting in a cured resin.

The term, “group” is used to describe a chemical substituent, the described chemical material includes the unsubstituted group and that group with O, N, Si, or S atoms, for example, in the chain (as in an alkoxy group) as well as carbonyl groups or other conventional substitution. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. As used herein, the term “group” is intended to be a recitation of both the particular moiety, as well as a recitation of the broader class of substituted and unsubstituted structures that includes the moiety.

The terms “hydroxyl number” and “hydroxyl value” are interchangeably used to describe the number of hydroxyl groups within a polyester resin, and are typically expressed as milligrams of potassium hydroxide (KOH) equivalent to the hydroxyl content of 1 gram of the hydroxyl-containing polyester (mg KOH/g polyester resin). Methods for determining hydroxyl numbers are well known in the art, and are defined, for example, according to ISO 4629-1978 and ASTM D1957-86 (“Standard Test Method for Hydroxyl Value of Fatty Oils and Acids”).

The term “hydroxyl functional polyester” is used to describe a polyester resin which predominantly has hydroxyl functional groups, and has a hydroxyl value that is higher than its acid value.

The term, “moiety” is used to describe a chemical compound or substituent, only an unsubstituted chemical material is intended to be included. For example, the phrase “alkyl moiety” is limited to the inclusion of only pure open chain saturated hydrocarbon alkyl substituents, such as methyl, ethyl, propyl, t-butyl, and the like.

The term “number average molecular weight” (Mₙ) is used to describe a method of reporting the average molecular weight of polymers in a mixture, calculated by dividing the total weight of all of the polymers in the sample divided by the number of polymers in a sample, using the equation, M̅_{N}=

$${\overline{M}}_{N} = \frac{{\sum }_{i} {N}_{i} {M}_{i}}{{\sum }_{i} {N}_{i}} ,$$

wherein Nᵢ is the number of polymers of molecular mass Mᵢ.

The term, “on”, when used in the context of a coating applied on a surface or substrate, includes both coatings applied directly or indirectly to the surface or substrate. Thus, for example, a coating composition of the present invention applied to a primary layer overlying a substrate constitutes a coating composition applied “on” the substrate.

The term, “plastic”, when used in the context of a substrate material, is used to describe any thermoplastic or thermosetting synthetic nonconductive material, including but not limited to thermoplastic olefins such as polyethylene and polypropylene, thermoplastic urethane, polycarbonate, thermosetting sheet molding compound, reaction-injection molding compound, acrylonitrile-based materials, nylon, and the like.

The term “polyester resin” is used to describe a resin which is the reaction product of a polycondensation reaction between alcohols and carboxylic acids and/or derivatives of carboxylic acids such as carboxylic acid anhydrides and esters of carboxylic acids.

The term “polymer” includes both homopolymers and copolymers (i.e., polymers of two or more different monomers). Similarly, unless otherwise indicated, the use of a term designating a polymer class such as, for example, “polyester” is intended to include both homopolymers and copolymers (e.g., polyester-urethane polymers).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “resin” is used to describe a crosslinked product of low molecular weight polymers having functional groups e.g., hydroxyl functional groups ( . . . —OH); the term “low molecular weight” means a number average molecular weight (Mₙ) of less than 15,000 Da.

In describing features herein as pertaining to “any of the various embodiments” or “in various embodiments”, the described feature should be understood to be capable of being combined with any other features and embodiments described within the description, unless such combination or use would be clearly unreasonable or contradict the usefulness or purpose of the described feature.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.). It will be understood that the total sum of any quantities expressed herein as percentages cannot (allowing for rounding errors) exceed 100%.

### Embodiments of the Present Invention

The coating compositions of the invention are formulated to address safety and performance issues associated with components included in, and the application of, coating compositions onto substrates during manufacturing. In particular, aluminum-pigmented paints, which can be utilized to provide color, texture, and sound dampening to a substrate, can produce hydrogen gas either upon coming in contact with water (Equation 1, below) or upon interacting with various pH adjusting chemicals that are commonly applied first to the substrate surface in coating systems that provide wear- and corrosion resistance, such chemicals including both acids (phosphates) and bases (amines). A reaction between aluminum and phosphoric acid to produce hydrogen gas is also shown in Equation 2, below.

2Al+6H₂O→2Al(OH)₃+3H₂ (1)

2Al+2H₃PO₄→2AlPO₄+3H₂ (2)

Many coating systems that comprise aluminum-pigmented paints further include one or more supplemental compounds in an attempt to stabilize the aluminum and prevent formation of hydrogen gas, and are applied to an adhesive and a base coating, which are disposed upon a substrate surface. However, as the coated substrates are mechanically stressed or operated at elevated temperatures, the multi-component coating systems can be prone to wear, corrosion, and damage in addition to the substrate itself.

Any of the coating compositions of the present invention can be applied to virtually any metallic or non-metallic substrate. Non-limiting examples of non-metallic substrates include: natural and/or synthetic stone, ceramics, glass, brick, cinderblock and composites, thereof; wallboard, drywall, sheetrock, cement board; plastics, composite plastics including SMC, GTX, nylon, melamine and/or acrylic composites, TPO, TPV, polypropylene, PVC, Styrofoam and the like; wood, wood laminates and/or wood composites, asphalt, fiberglass, and concrete. Non-limiting examples of metallic substrates include materials containing ferrous metals, zinc, copper, magnesium, and/or aluminum, and alloys thereof, and other metal and alloy substrates typically used in the manufacture of automobile and other vehicle bodies. The ferrous metal substrates used in the practice of the present invention may include iron, steel, and alloys thereof. Non-limiting examples of useful steel materials include cold rolled steel, galvanized steel, electrogalvanized steel, stainless steel, pickled steel, zinc-iron alloy, and combinations thereof. Combinations or composites of ferrous and non-ferrous metals can also be used.

In some embodiments, the substrate is a machine element that can be combined with other elements into a mechanical part, assembly, or other component. Non-limiting examples of machine elements include structural elements such as frame members, beams, struts, bearings, axles, splines, seals, keys, fasteners, and machine guardings, as well as mechanical elements such as shafts, couplings, drives, gears and gear trains, chains, belts and the like. Those skilled in the art would appreciate that these are non-exhaustive lists of structural and mechanical machine elements, and that the variations of machine elements that can be substrates, and the mechanical parts containing those substrates, are nearly endless.

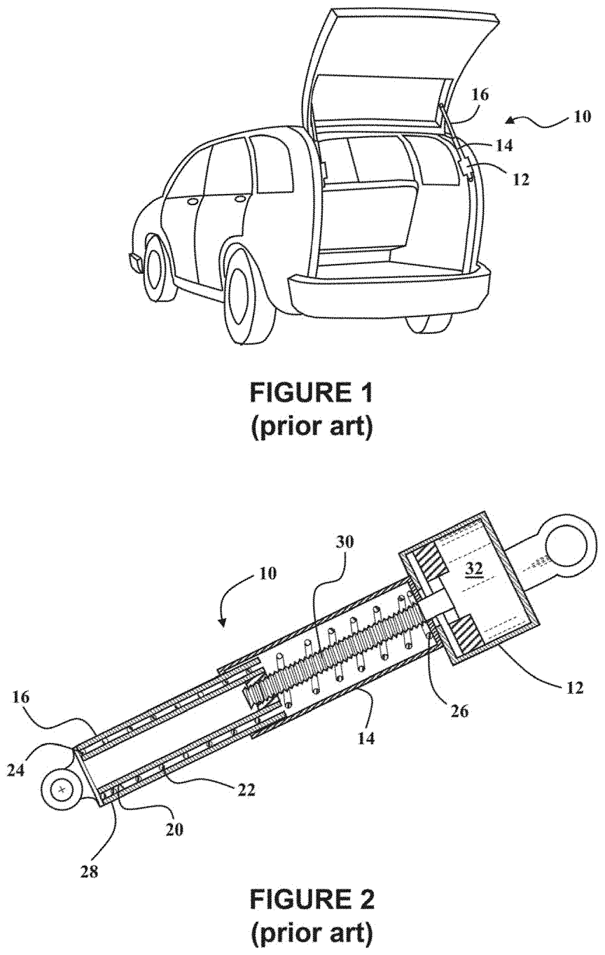

In one non-limiting example, and in some embodiments, the substrate coated with any of the coating compositions of the present invention is a spring, which is designed for assembly with other machine elements into a support strut, which facilitates the opening and closing of the rear hatch (also referred to interchangeably herein as a “tailgate” or “liftgate”) of a van, SUV, or hatchback vehicle. FIG. 1 shows an illustration of a pair of support struts 10 mounted to a vehicle and supporting the vehicle's liftgate, whereas FIG. 2 shows a cross-section of an exemplary electromechanical support strut from the prior art in an extended position.

As illustrated in FIG. 2, a spring 22 is seated within a toroidal chamber 20 inside the strut 10. The spring 22 includes one end 24 connected to the end 28 of an extensible shaft 16, and another end 26 connected to an upper housing 14 adjacent a lower housing 12. The spring 22 is a coil spring that uncoils and recoils as the extensible shaft 16 moves relative to the upper 14 and lower 12 housings. In use, the spring 22 provides a mechanical counterbalance to the weight of the liftgate and also assists in raising the liftgate. When the extensible shaft 16 is in the retracted position, the spring 22 is tightly compressed between the extensible shaft 16 and the lower housing 12. As a power screw 30 rotates to extend the shaft 16, the spring 22 extends as well, releasing its stored energy and transmitting an axial force through the shaft 16 to help raise the liftgate. When the power screw 30 rotates to retract the extensible shaft 16, or when the liftgate is manually closed, the spring 22 is compressed between the shaft 16 and the lower housing 12 and thus recharges. Further, in addition to assisting in driving the power screw 30, the spring 22 provides a preloading force for reducing starting resistance and wear of an associated motor 32, and also provides dampening assistance when the liftgate is closed.

Accordingly, support strut springs, such as the springs within exemplary support struts of FIGS. 1 and 2 as well as other gas-loaded, spring-loaded, and electromagnetic support struts in the art, are generally contained within a narrow, cylindrical shaft that facilitates extension and compression along the axis of the spring during operation of the liftgate. However, in practice, sections of the spring can also flex along an axis perpendicular to the spring, causing the spring to strain into an S-shape and contact the internal surface of the shaft. The rubbing of the spring against the shaft creates noise during operation of the liftgate and causes the coating(s) on the surface of the spring to wear away. Over time, the surface of the spring becomes exposed, and moisture that infiltrates the strut can cause the spring to corrode.

Accordingly, the present invention provides coating compositions that can be applied to a substrate, such as a support strut spring, and withstand physical and environmental conditions within the strut. The coating compositions can be applied as a single-composition coating system, with no additional coating layers or flocking required. However, in some embodiments, the coating compositions of the present invention can optionally be applied as a multi-component coating system, along with one or more additional compositions and/or flocking. Once in place, the coating compositions of the present invention can provide wear and corrosion resistance to a substrate, as well as sound dampening when the coated substrate is contacted with another object.

In one embodiment, coating compositions of the present invention generally comprise (a) at least one ketone; (b) at least one functionalized resin; and (c) at least one dry lubricant.

A ketone can comprise at least one ketone moiety, although a typical ketone comprises just a single ketone moiety. Ketones generally possess some miscibility with water, and represent the primary solvent for coating compositions of the present invention. Non-limiting examples of a ketone include acetone; methyl ethyl ketone; methyl propyl ketone; methyl isopropyl ketone; methyl butyl ketone; methyl isobutyl ketone; methyl amyl ketone; methyl isoamyl ketone; diethyl ketone; ethyl amyl ketone; dipropyl ketone; diisopropyl ketone; cyclohexanone; methylcyclohexanone; trimethylcyclohexanone; mesityl oxide; di-isobutyl ketone; and isophorone. In some embodiments, one or more of the above ketones can be comprised with a coated composition of the present invention. In some embodiments, a ketone can be selected based on its compatibility with application as a spray, particularly an electrostatic spray, whereas others may be chosen based on their evaporation rate once applied. As a non-limiting example, and in some embodiments, one or more ketones can be selected from the group consisting of methyl amyl ketone; methyl aryl ketone; methyl ethyl ketone; methyl isopropyl ketone; and methyl isobutyl ketone. In some embodiments, the coating composition can comprise an azeotrope comprising at least one ketone and one or more additional co-solvents. Such co-solvents are discussed in further detail below.

In some embodiments, the at least one ketone can be at least about 5% by weight, at least about 10% by weight, at least about 15% by weight, at least about 20% by weight, at least about 25% by weight, at least about 30% by weight, at least about 35% by weight, at least about 40% by weight, or at least about 45% by weight, and up to about 50% by weight, up to about 45% by weight, up to about 40% by weight, up to about 35% by weight, up to about 30% by weight, up to about 25% by weight, up to about 20% by weight, up to about 15% by weight, or up to about 10% by weight of the coating composition. In some embodiments, the at least one ketone can comprise at least about 25% by weight, and up to about 45% by weight, of the coating composition. In some embodiments, the at least one ketone can comprise at least about 30%/4 by weight, and up to about 40% by weight, of the coating composition. In some embodiments, the at least one ketone can comprise at least about 30% by weight, and up to about 50% by weight, of the coating composition.

In some embodiments, the at least one ketone can be selected from the group consisting of methyl ethyl ketone and methyl isopropyl ketone, including combinations thereof. In some embodiments in which the at least one ketone consists of methyl ethyl ketone and methyl isopropyl ketone, the total mass of the ketones within the coating composition can be at least about 20% by weight, at least about 25% by weight, at least about 30% by weight, at least about 35% by weight, at least about 40% by weight, or at least about 45% by weight, and up to about 50% by weight, up to about 45% by weight, up to about 40% by weight, up to about 35% by weight, up to about 30% by weight, or up to about 25% by weight of the coating composition. In some embodiments in which the at least one ketone consists of methyl ethyl ketone and methyl isopropyl ketone, methyl isopropyl ketone can be at least about 5% by weight, or at least about 10% by weight, and up to about 15% by weight, or up to about 10% by weight of the coating composition, whereas the methyl ethyl ketone can be at least about 15% by weight, or at least about 20% by weight, and up to about 25% by weight, or up to about 20% by weight, of the coating composition.

In addition to a ketone, any of the compositions of the present invention can also comprise one or more co-solvents, for dispersing components within the composition and/or for modifying the overall viscosity of the composition. The co-solvent can be organic solvent, non-limiting examples of which can include: aromatic hydrocarbons (e.g., benzene, toluene, xylene, mesitylene, SOLVENT NAPHTHA 100, 150, and 200 products, and the like); alcohols (e.g., methanol, ethanol, n-propanol, isopropanol, n-butanol, iso-butanol and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol esters (e.g., butyl glycol acetate, methoxypropyl acetate and the like); reactive diluents such as, for example, hexane diacrylate, trimethylol propane diacrylate, 1,6 hexanediol diacrylate, 1,6 hexanediol dimethacrylate, 1,4 butanediol diacrylate, 1,4 butanediol dimethacrylate, or pentaerythritol triacrylate; or a mixture thereof.

In some embodiments, the co-solvent is either an alcohol, an aromatic hydrocarbon, or a mixture thereof. In some embodiments, the co-solvent is one or more of the isomers of xylene-ortho-xylene, meta-xylene, and/or para-xylene (hereinafter collectively referred to as “xylene”). In some embodiments, the co-solvent is ethanol. In some embodiments, the co-solvent is a combination of xylene and ethanol. In some embodiments, any of the coating compositions of the present invention can comprise at least about 2% by weight, at least about 5% by weight, at least about 10% by weight, at least about 15% by weight, or at least about 20% by weight, and up to about 25% by weight, up to about 20% by weight, up to about 15% by weight, up to about 10% by weight, or up to about 5% by weight of the co-solvent.

In some embodiments, the coating composition is a solvent-based coating composition that preferably includes no more than 2% by weight of water, if water is inherently present as a solvent for one or more of the composition components prior to formulation. In other embodiments, the coating contains no water, from any source.

The use of resins within coating compositions is well known in the art. Many coatings that are hard and/or inflexible once they are cured, and in some instances, the composition of the resins themselves cause the resins to either be difficult or unsafe to apply to a substrate using a high-energy application method such as electrostatic spraying. For example, some polymers and resins are prepared and/or stored in the presence of formaldehyde, which although not universally regulated in every country, is strictly controlled or prohibited in others for such applications as electrostatic spraying. However, some functionalized resins utilized in the production of liquid inks contain components that are safe to apply to a substrate, even by electrostatic spraying, and once cured on the substrate surface, form coatings that can withstand excessive wear while remaining flexible. Therefore, in jurisdictions in which the spraying of formaldehyde is regulated or prohibited, the present invention provides formaldehyde-free compositions for applying coating compositions using electrostatic spray. Otherwise, any of the compositions of the present invention, whether they contain formaldehyde or not, can be applied to a substrate using electrostatic spray, dip spinning, or any method known in the art for coating metallic or plastic substrates. Non-limiting examples of suitable resins include phenolic, polyketone and polyester resins, including but not limited to resins produced and sold under the REACTOL™ line by Lawter, Inc., particularly REACTOL™ resins 1111A, 1111E, 1717, 1717A, 1717BC, 1717E, 1717H, 1979A, and 5145A, all of which are marketed for their high gloss, adhesion to wood and paper, and pigment wetting characteristics.

Additionally, polymers within resin compositions can be characterized by the identity and relative quantity of reactive functional groups present, including but not limited to: alcohols, including hydroxyl groups; acids, including carboxylic acid groups; anhydrides; acyl groups; or esters. In some embodiments, polymer resins containing any of the above functional groups can be formed to have low viscosity, low volatile organic compound (VOC) content, and enhanced flexibility.

In one non-limiting example, and in some embodiments, the resin composition can be a low molecular weight (e.g., less than 15,000 Da) hydroxyl functional polyester composition, which are known in the art to be readily cross-linkable through their hydroxyl groups. Non-limiting examples of suitable hydroxyl-reactive crosslinking agents include: aminoplasts, which are typically oligomers that are the reaction products of aldehydes, particularly formaldehyde; amino- or amido-group-carrying substances exemplified by melamine, urea, dicyandiamide, benzoguanamine and glycoluril; blocked isocyanates, or a combination thereof. Crosslinking agents are described in further detail, below.

In some embodiments, the backbone of a hydroxyl functional polyester is hydroxyl-terminated and/or carboxyl-terminated.

In some embodiments, hydroxyl functional polyester polymers may have any hydroxyl number. Hydroxyl numbers are typically expressed as milligrams of potassium hydroxide (KOH) equivalent to the hydroxyl content of 1 gram of the hydroxyl-containing substance, and are typically inversely proportional to the viscosity of the composition. Thus, hydroxyl functional polyester compositions having a low hydroxyl number (e.g., less than 150) have a higher viscosity than compositions having a higher hydroxyl number. On the other hand, coatings made from hydroxyl functional polyesters having high hydroxyl numbers (e.g., greater than 300) can become brittle.

In some embodiments, a hydroxyl functional polyester utilized in a composition of the present invention can have a hydroxyl number of at least about 150, at least about 175, at least about 200, at least about 225, at least about 250, or at least about 275, and up to about 300, up to about 275, up to about 250, up to about 225, up to about 200, or up to about 175. In some embodiments, the hydroxyl functional polyester has a hydroxyl number of at least about 250, and up to about 300. In some embodiments, the hydroxyl functional polyester has a hydroxyl number of at least about 270, and up to about 280. In some embodiments, the hydroxyl functional polyester has a hydroxyl number of about 280.

In some embodiments, hydroxyl functional polyester polymers may have any suitable acid number. Acid numbers are typically expressed as milligrams of KOH required to titrate a 1-gram sample to a specified end point. As with hydroxyl numbers, methods for determining acid numbers are well known in the art. In some embodiments, a hydroxyl functional polyester utilized in a composition of the present invention can have an acid number of at least about 0, at least about 1, at least about 2, at least about 4, at least about 6, or at least about 8, and up to about 10, up to about 8, up to about 6, up to about 4, up to about 2, or up to about 1. In some embodiments, the hydroxyl functional polyester has an acid number of at least about 1, and up to about 10. In some embodiments, the hydroxyl functional polyester has an acid number of at least about 6, and up to about 8. In some embodiments, the hydroxyl functional polyester has a hydroxyl number of at least about 250, and up to about 300, and an acid number of at least about 6, and up to about 8.

In some embodiments, the at least one functionalized resin, particularly in embodiments in which the at least one functionalized resin is selected to be a hydroxyl functional polyester, can be at least about 10% by weight, at least about 15% by weight, at least about 20% by weight, at least about 25% by weight, or at least about 30% by weight, and up to about 35% by weight, up to about 30% by weight, up to about 25% by weight, up to about 20% by weight, or up to about 15% by weight of the coating composition. In some embodiments, the at least one functionalized resin is selected to be a hydroxyl functional polyester, and the hydroxyl functional polyester comprises at least about 10% by weight, and up to about 25% by weight of the composition. In some embodiments, a hydroxyl functional polyester comprises at least about 15% by weight of the composition, and up to about 30% by weight of the composition.

Adding dry additives to coating compositions to provide, or enhance, lubrication is also well known in the art for use in industrial and commercial applications, particularly whenever two or more solid surfaces move in close contact relative to each other, particularly in extreme temperature and pressure use conditions. Such additives can be either organic or inorganic solids, either of which are commonly suspended or dissolved within the composition, based on the liquid solvent(s) and/or base(s) utilized when forming the compositions. In some embodiments, any of the compositions of the present invention can comprise one or more inorganic solids as dry lubricants. Non-limiting examples of such suitable inorganic solids are graphite, molybdenum disulfide, boron nitride, tungsten carbide, and tungsten disulfide, including combinations thereof.

The inorganic solids in the above list are all recognized as providing lubricant characteristics to compositions, and are widely used and commercially available. Further, they are either available, or are modifiable, to a wide variety of particle sizes prior to their addition into the composition. In some embodiments, an inorganic solid utilized as a dry lubricant can have a mean particle size less than about 30 microns, as many filters separate out larger particles as an impurity. In some embodiments, the mean particle size of an inorganic solid used as a dry lubricant can be less than about 10 microns, less than about 1 micron, or less than about 0.25 microns. In some embodiments, the mean particle size of an inorganic solid used as a dry lubricant is at least about 1 micron, and up to about 10 microns.

In some embodiments, molybdenum disulfate can be selected because of cost, ready availability in proper micron size, high operating temperature capability and overall long-term performance. In some embodiments, a molybdenum disulfide and graphite mixture can be utilized, in which the ratio of molybdenum disulfide to graphite is in a range from about 3:7, up to about 7:3. In some embodiments, the at least one dry lubricant comprises molybdenum disulfide, and the molybdenum disulfide comprises at least about 2% by weight, at least about 4% by weight, at least about 6% by weight, at least about 8% by weight, or at least about 10% by weight, and up to about 12% by weight, up to about 10% by weight, up to about 8% by weight, up to about 6% by weight, or up to about 4% by weight of the coating composition. In some embodiments, molybdenum disulfide comprises at least about 6% by weight, and up to about 12% by weight of the coating composition. In some embodiments, molybdenum disulfide comprises at least about 6% by weight, and up to about 12% by weight of the coating composition.

In some embodiments, the at least one dry lubricant can comprise one or more organic fluoropolymers. Non-limiting examples of suitable fluoropolymers that can be utilized as dry lubricants in coating compositions of the present invention are polyvinylfluoride (PVF), polyvinylidene fluoride (PVDF), polytetrafluoroethylene (PTFE), polychlorotrifluoroethylene (PCTFE), perfluoroalkoxy polymer (PFA), fluorinated ethylene-propylene (FEP), perfluorinated elastomer (FFPM), polyethylenetetrafluoroethylene (ETFE), polyethylenechlorotrifluoroethylene (ECTFE), fluoroelastomer with vinylidene fluoride based copolymers (FPM/FKM), fluoroelastomer [tetrafluoroethylene-propylene] (FEPM); perfluoropolyether (PFPE); and perfluorosulfonic acid (PFSA).

As with the inorganic solids above, several of the organic fluoropolymers are widely used and commercially available, and they are also either available, or are modifiable, to a wide variety of particle sizes prior to their addition into the composition. In some embodiments, a fluoropolymer utilized as a dry lubricant can have a mean particle size less than about 30 microns, as many filters separate out larger particles as an impurity. In some embodiments, the mean particle size of a fluoropolymer used as a dry lubricant can be less than about 10 microns, less than about 1 micron, or less than about 0.25 microns. In some embodiments, the mean particle size of a fluoropolymer used as a dry lubricant is at least about 1 micron, and up to about 10 microns.

In some embodiments, PTFE can be selected because of cost, ready availability in proper micron size, high operating temperature capability and overall long-term performance. In some embodiments, the at least one dry lubricant comprises PTFE, and the PTFE comprises at least about 2% by weight, at least about 5% by weight, at least about 8% by weight, at least about 10% by weight, or at least about 12% by weight, and up to about 14% by weight, up to about 12% by weight, up to about 10% by weight, up to about 8% by weight, or up to about 5% by weight of the coating composition. In some embodiments, PTFE comprises at least about 10% by weight, and up to about 14% by weight of the coating composition.

In order to facilitate the formation of a coating on the substrate surface and enhance the curing of the functionalized resin(s) the coating composition can further comprise a cross-linking agent, wherein the cross-linking agent is capable of cross-linking the functionalized resin(s). In particular, hydroxyl functional polyesters are curable through the hydroxyl groups. Suitable hydroxyl-reactive crosslinking agents may include, but are not limited to: aminoplasts; amino- or amido-group-carrying substances exemplified by melamine, urea, dicyandiamide, benzoguanamine and glycoluril; and polyisocyanates, including blocked polyisocyanates, and combinations thereof.

Aminoplasts are obtained by the condensation reaction of formaldehyde with an amine or an amide. While the aldehyde employed is most often formaldehyde, other aldehydes such as acetaldehyde, crotonaldehyde, benzaldehyde and furfural may be used. Aminoplasts often contain methylol or similar alkylol groups, and sometimes, at least a portion of the alkylol groups are etherified by reaction with alcohol to provide organic solvent-soluble resins. Typically, monohydric alcohols, including such alcohols as methanol, ethanol, butanol and hexanol, are utilized for this reaction. The most common amines or amides are melamine, urea or benzoguanamine. However, condensation with other amines or amides can be employed. Non-limiting examples of amino cross-linking agent include those sold by Cytec under the trade name CYMEL®, particularly the CYMEL® 301, 303, and 385 alkylated melamine-formaldehyde resins). In a further non-limiting example, the CYMEL® 303 LF resin is a highly methylated, monomeric melamine cross-linking agent, which while insoluble in water, is compatible with water-soluble backbone polymers, stable in amine-stabilized water-borne formulations, and provides high flexibility and formability in the resulting coating(s) even with inherently inflexible functionalized resins, such as hydroxyl functional polyester resins.

In addition to an aminoplast, a catalyst can be added to the coating composition to enhance the reactivity between the aminoplast and the hydroxyl functional polyester, both lowering the temperature and reducing the amount of time required for curing. In instances where an aminoplast is the cross-linking agent, acid catalysts can be utilized. A non-limiting example of an acid catalyst compatible with an aminoplast is the CYCAT® 4045 catalyst, which also available from Cytek. The CYCAT® 4045 catalyst is an amine-blocked para-toluene sulfonic acid, compatible with highly-alkylated amino cross-linking agents, such as the example CYMEL® 303 LF resin described above. Generally, blocked catalysts such as CYCAT® 4045 offer improved stability within the formulation relative to unblocked acid catalysts (such as, as a non-limiting example CYCAT® 4040). However, unblocked acid catalysts can be used in compositions of the present invention as well, and actually offer a higher cure rate relative to blocked catalysts.

Polyisocyanates and blocked polyisocyanates may also be used as curing agents for the functionalized resins. Non-limiting examples of polyisocyanates include monomeric polyisocyanates such as toluene diisocyanate and 4,4′-methylene-bis(cyclohexyl isocyanate), and isophorone diisocyanate. On the other hand, blocked polyisocyanates are polyisocyanates in which isocyanate groups have reacted with a protecting or blocking agent to form a derivative that will dissociate on heating to remove the protecting or blocking agent and release the reactive isocyanate group. Some examples of suitable blocking agents for polyisocyanates include aliphatic, cycloaliphatic or aralkyl monohydric alcohols, hydroxylamines and ketoximes.

It is within the ability of those skilled in the art to select the identities and quantities of a cross-linking agent and optionally, a catalyst, based on the properties desired in the cured resin. Technical data sheets provided by the manufacturers and/or suppliers describe detailed instructions, optimal compatibility, and suggested reaction conditions for reacting a cross-linking agent with functionalized resins, as well as for combining a catalyst with a cross-linking agent. In some embodiments, the cross-linking agent is a methylated melamine monomer, and the chemical catalyst is an amine-blocked para-toluene sulfonic acid.

In some embodiments, the mass ratio of the cross-linking agent to the chemical catalyst is at least about 2:1, at least about 4:1, at least about 6:1, at least about 8:1, or at least about 10:1, and up to about 12:1, up to about 10:1, up to about 8:1, up to about 6:1, or up to about 4:1. In some embodiments, the mass ratio of the cross-linking agent to the chemical catalyst is in a range from about 8:1 up to about 12:1, and is preferably about 10:1.

Additionally, and in some embodiments, a coating composition of the present invention can comprise at least about 1% by weight, at least about 2% by weight, at least about 3% by weight, at least about 4% by weight, or at least about 5% by weight, and up to about 6% by weight, up to about 5% by weight, up to about 4% by weight, up to about 3% by weight, or up to about 2% by weight of the methylated melamine monomer. In some embodiments, a coating composition of the present invention can comprise at least about 0.1% by weight, at least about 0.2% by weight, at least about 0.3% by weight, at least about 0.4% by weight, or at least about 0.5% by weight, and up to about 0.6% by weight, up to about 0.5% by weight, up to about 0.4% by weight, up to about 0.3% by weight, or up to about 0.2% by weight of the amine-blocked para-toluene sulfonic acid catalyst. In some embodiments, a coating composition of the present invention can comprise at least about 2% by weight, and up to about 3% by weight, of a methylated melamine monomer, and also comprise at least about 0.02% by weight, and up to about 0.3% by weight, of the amine-blocked para-toluene sulfonic acid catalyst.

In some embodiments, any of the coating compositions described herein can comprise a colorant, typically comprising one or more pigments. The coating compositions can support any desired color, including colors that coincide with a motor vehicle part, or the motor vehicle itself. Some colorants consist of pigments which themselves are dispersed in their own resin system, such as the Opticolor® 4000 and XP 4100 product lines, which are dispersed in an aldehyde resin system along with a blend of ester solvents, and are able to react with crosslinking systems rather than dilute them. In some embodiments, a coating system of the present invention can comprise at least about 0.1% by weight, at least about 0.5% by weight, at least about 1% by weight, or at least about 1.5% by weight, and up to about 2.0% by weight, up to about 1.5% by weight, up to about 1.0% by weight, or up to about 0.5% by weight.

While particular embodiments of the invention have been described, the invention can be further modified within the spirit and scope of this disclosure. Those skilled in the art will recognize, or be able to ascertain using no more than routine experimentation, numerous equivalents to the specific procedures, embodiments, claims, and examples described herein. As such, such equivalents are considered to be within the scope of the invention, and this application is therefore intended to cover any variations, uses or adaptations of the invention using its general principles. Further, the invention is intended to cover such departures from the present disclosure as come within known or customary practice in the art to which this invention pertains and which fall within the appended claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The contents of U.S. Patent Nos. are hereby incorporated by reference, and shall not be construed as an admission that such reference is available as prior art to the present invention. All of the incorporated publications and patent applications in this specification are indicative of the level of ordinary skill in the art to which this invention pertains, and are incorporated to the same extent as if each individual publication or patent application was specifically indicated and individually indicated by reference.

### Detailed Description of the Invention

The following working and prophetic examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. Thus, while the present invention has been described above with particularity, the following examples provide further detail in connection with what are presently deemed to be the most practical and preferred embodiments of the invention.

### Example 1

Coating compositions having the components listed in the table below were formulated according to the following procedure. The quantity of each of the components is listed as percent by mass of the composition.

| | Formula | Formula | Formula | Formula |
|---|---|---|---|---|
| | 1 | 2 | 3 | 4 |
| Methyl Isopropyl Ketone | 12.2% | 12.2% | 9.1% | 9.06% |
| Methyl Ethyl Ketone | 22.5% | 22.5% | 22.5% | 22.5% |
| Ethanol | 22.5% | — | 22.5% | — |
| Xylene | — | 22.5% | — | 22.5% |
| Hydroxyl Functional | 18.2% | 18.2% | 21.36% | 21.36% |
| Polyester (Lawter Inc., | | | | |
| REACTOL ™ 1979A) | | | | |
| Crosslinking Agent | 3.1% | 3.1% | 3.1% | 3.1% |
| (Allnex Group, CYMEL ® | | | | |
| 303 LF resin) | | | | |
| Curing Catalyst | 0.28% | 0.28% | 0.28% | 0.28% |
| (Cytec Industries Inc., | | | | |
| CYCAT ® 4045 catalyst) | | | | |
| Molybdenum Disulfide, | 8.1% | 8.1% | 8.1% | 8.1% |
| Fine Grade (Rose Mill, | | | | |
| CAS 1317-33-5) | | | | |
| Polytetrafluoroethylene, | 12.0% | 12.0% | 12.0% | 12.0% |
| micronized (Micro Powders | | | | |
| Inc., Fluo HT ™) | | | | |
| Colorant | 1.1% | 1.1% | 1.1% | 1.1% |
| (EPS Materials, Opticolor ® | | | | |
| 4095 Lamp Black) | | | | |

Powdered REACTOL™ 1979A was dispersed into a blend of the three solvents (methyl isopropyl ketone, methyl ethyl ketone, and ethanol (or xylene)) in a container and mixed to uniformity using a high-speed dispersion blade at approximately 2000 RPM. The quantity of the solvent blend was approximately equivalent to about 60% of the total mass of the three solvents in the completed formulation. Once the REACTOL™ 1979A was completely dispersed into the solvent blend, the remaining solids were added sequentially by adding a single solid component, and mixing until the solid was completely wetted and dispersed, at least 20 minutes, prior to adding and mixing the next solid component. When the Fluo HT™ was added, the mixing speed was reduced to avoid excessive foaming. Once all solids were dispersed, the remaining solvent blend was added into the composition and blended to uniformity.

### Example 2

A coating composition having the components listed in the table below was formulated according to the following procedure. The quantity of each of the components is listed as percent by mass of the composition.

| | Formula 5 |
|---|---|
| Methyl Isopropyl Ketone | 22.5% |
| Methyl Ethyl Ketone | 22.5% |
| Phenolic Resin | 34.0% |
| (Lawter Inc., REACTOL ™ 1111A) | |
| Molybdenum Disulfide, Fine Grade | 8.1% |
| (Rose Mill, CAS 1317-33-5) | |
| Polytetrafluoroethylene, micronized | 12.0% |
| (Micro Powders Inc., Fluo HT ™) | |
| Colorant | 1.1% |
| (EPS Materials, Opticolor ® 4095 Lamp Black) | |

Liquid REACTOL™ 1111A was dispersed into a container and mixed to uniformity using a high-speed dispersion blade at approximately 2000 RPM. A blend of the two solvents (methyl isopropyl ketone and methyl ethyl ketone) was added to the container and mixed to uniformity. The quantity of the solvent blend was approximately equivalent to about 60% of the total mass of the three solvents in the completed formulation. Once the REACTOL™ 1111A was completely dispersed into the solvent blend, the remaining solids were added sequentially by adding a single solid component, and mixing until the solid was completely wetted and dispersed, at least 20 minutes, prior to adding and mixing the next solid component. When the Fluo HT™ was added, the mixing speed was reduced to avoid excessive foaming. Once all solids were dispersed, the remaining solvent blend was added into the composition and blended to uniformity.

### Example 3

A coating composition having the components listed in the table below was formulated according to the following procedure. The quantity of each of the components is listed as percent by mass of the composition.

| | Formula 6 |
|---|---|
| Methyl Isopropyl Ketone | 44.6% |
| Xylene | 4.0% |
| Hydroxyl Functional Polyester | 30.3% |
| (Lawter Inc., REACTOL ™ 1979A) | |
| Crosslinking Agent | 2.0% |
| (Allnex Group, CYMEL ® 303 LF resin) | |
| Curing Catalyst | 0.2% |
| (Cytec Industries Inc., CYCAT ® 4045 catalyst) | |
| Molybdenum Disulfide, Fine Grade | 7.3% |
| (Rose Mill, CAS 1317-33-5) | |
| Polytetrafluoroethylene, micronized | 10.6% |
| (Micro Powders Inc., Fluo HT ™) | |
| Colorant | 1.0% |
| (EPS Materials, Opticolor ® 4095 Lamp Black) | |

Powdered REACTOL™ 1979A was dispersed into a blend of the two solvents (methyl isopropyl ketone and xylene) in a container and mixed to uniformity using a high-speed dispersion blade at approximately 2000 RPM. The quantity of the solvent blend was approximately equivalent to about 60% of the total mass of the three solvents in the completed formulation. Once the REACTOL™ 1979A was completely dispersed into the solvent blend, the remaining solids were added sequentially by adding a single solid component, and mixing until the solid was completely wetted and dispersed, at least 20 minutes, prior to adding and mixing the next solid component. When the Fluo HT™ was added, the mixing speed was reduced to avoid excessive foaming. Once all solids were dispersed, the remaining solvent blend was added into the composition and blended to uniformity.

### Example 4

Coating compositions having the components listed in the table below are formulated according to the following procedure. The quantity of each of the components is listed as percent by mass of the composition.

| | Formula 7 | Formula 8 | Formula 9 |
|---|---|---|---|
| Methyl Isopropyl Ketone | 8-15% | 8-15% | 8-15% |
| Methyl Ethyl Ketone | 20-25% | 20-25% | 20-25% |
| Ethanol | 20-25% | 20-25% | 20-25% |
| Hydroxyl Functional Polyester | 12-25% | — | — |
| Phenolic Resin | — | 12-25% | — |
| Polyketone Rosin | — | — | 12-25% |
| Crosslinking Agent | 3-6% | 3-6% | 3-6% |
| Curing Catalyst | 0.1-0.38% | 0.1-0.38% | 0.1-0.38% |
| Molybdenum Disulfide | 6-12% | 6-12% | 6-12% |
| Perfluoroalkoxy Polymer Powder | 10-14% | 10-14% | 10-14% |
| Colorant | 1-2% | 1-2% | 1-2% |

The functionalized resin (hydroxyl functional polyester, phenolic resin, or polyketone resin, respectively) is dispersed into a blend of the three solvents (methyl isopropyl ketone, methyl ethyl ketone, and ethanol) in a container and mixed to uniformity using a high-speed dispersion blade at approximately 2000 RPM. The quantity of the solvent blend is approximately equivalent to about 60% of the total mass of the three solvents in the completed formulation. Once the functionalized resin is completely dispersed into the solvent blend, the remaining solids are added sequentially by adding a single solid component, and mixing until the solid is completely wetted and dispersed, at least 20 minutes, prior to adding and mixing the next solid component. When the perfluoroalkoxy polymer powder is added, the mixing speed is reduced to avoid excessive foaming. Once all solids are dispersed, the remaining solvent blend is added into the composition and blended to uniformity.

### Example 5

Coating compositions having the components listed in the table below are formulated according to the following procedure. The quantity of each of the components is listed as percent by mass of the composition.

| | Formula | Formula | Formula | Formula | Formula |
|---|---|---|---|---|---|
| | 10 | 11 | 12 | 13 | 14 |
| Ethanol | 40-50% | 40-50% | 40-50% | — | — |
| Methyl Isopropyl | — | — | — | 15-20% | 25-35% |
| Ketone | | | | | |
| Methyl Ethyl Ketone | — | — | — | 30-35% | — |
| Hydroxyl Functional | 30-35% | — | — | — | — |
| Polyester | | | | | |
| Phenolic Resin | — | 30-35% | — | 25-40% | 12-20% |
| Polyketone Resin | — | — | 30-35% | — | — |
| Phenol | — | — | — | — | 12-20% |
| Anhydrous Methanol | — | — | — | — | 17-25% |
| Boron Nitride | 6-12% | 6-12% | 6-12% | — | — |
| Molybdenum Disulfide | — | — | — | 10-15% | 10-15% |
| Perfluoroalkoxy | 10-14% | 10-14% | 10-14% | — | — |
| Polymer Powder | | | | | |
| Polytetrafluoroethylene | — | — | — | 10-15% | 10-15% |
| Powder | | | | | |
| Carbon Black | — | — | — | 0.3-1% | 0.3-1% |
| Colorant | 1-2% | 1-2% | 1-2% | — | — |

The functionalized resin (hydroxyl functional polyester, phenolic resin, or polyketone resin, respectively) is dispersed into a solvent or solvent blend in a container and mixed to uniformity using a high-speed dispersion blade at approximately 2000 RPM. The quantity of the solvent or solvent blend is approximately equivalent to about 60% of its total mass in the completed formulation. Once the functionalized resin is completely dispersed into the solvent blend, the remaining solids are added sequentially by adding a single solid component, and mixing until the solid is completely wetted and dispersed, at least 20 minutes, prior to adding and mixing the next solid component. When the perfluoroalkoxy polymer powder or polytetrafluoroethylene powder is added, the mixing speed is reduced to avoid excessive foaming. Once all solids are dispersed, the remaining solvent blend is added into the composition and blended to uniformity.

### Example 6: Dip-Spin Application of Coating Compositions to Substrates

In accordance with the embodiments of the present disclosure, a substrate is coated with any of the Formulas 1-14 of the coating composition using a dip-spin coating system. Briefly, a dip-coating system typically comprises a wire or other mesh basket that can be submerged into a coating composition within a dip tank for a time sufficient to wet the entire substrate surface. While immersed in the coating, the basket is slowly rotated which assists in the elimination of air-pockets and improves substrate surface wetting. After the dipping process, the basket is removed from the dip-tank and rotated or centrifuged, so that the coated parts are thrown against the outer wall of the basket. Excess coating is removed from the parts due to the centrifugal force and escapes through small holes in the basket back into the dip tank. The wetted substrate is then transferred to a curing oven and heated for a time sufficient to form a cross-linked resin within atop the substrate, while also evaporating any residual solvent that may be present.

In particular, support strut springs were coated with a coating composition of either Formula 1, Formula 3, Formula 5, or Formula 6, respectively, using a dip-spinning system. Each of the coated substrates was cured in two stages. The first stage was a drying stage, in which the coated substrate(s) were allowed to dry at 150° F. within a curing oven for at least 20 minutes. The second stage was a curing stage, in which the curing oven temperature was elevated to 350° F., and the coated substrates were typically cured for 10-30 minutes, depending of the relative humidity of the surrounding environment. Without being limited by a particular theory, it is believed that faster curing can be achieved at elevated temperatures (e.g., 450° F.), however, curing too fast can lead to defects in the cured structure and an ultimately weaker overall strength.

### Example 7: Electrostatic Application of Coating Compositions to Substrates

In accordance with the embodiments of the present disclosure, a substrate is coated with any of the Formulas 1-14 of the coating composition using an electrostatic spray device. Without being limited by a particular theory, it is believed that applying the coating composition as a charged spray can facilitate an even thickness across the entire substrate surface, including areas that are not adjacent and/or blocked relative to the spray nozzle. As with dip-spinning, the wetted substrate is then transferred to a curing oven and heated for a time sufficient to form a cross-linked resin within atop the substrate, while also evaporating any residual solvent that may be present.

In particular, support strut springs were coated with the coating composition of Formula 5 using an electrostatic spray device, with a 1 mm spray nozzle at 35 pounds per square inch. Coating thicknesses were applied in ranges from 0.0005-0.0015 inches thick. Each of the coated substrates were allowed to dry at 150° F. within a curing oven for 10-20 minutes, followed by curing at 350° F. for 10-30 minutes, depending of the relative humidity of the surrounding environment.

### Example 8: Corrosion Resistance of Coated Substrates

The corrosion resistance of a support strut spring coated with either Formula 1, Formula 3, Formula 5, or Formula 6 was tested according to the American Society for Testing and Materials (ASTM) B117 method, “Standard Practice for Operating Salt Spray (Fog) Apparatus”, which covers the apparatus, procedure, and conditions required to create and maintain the salt spray (fog) test environment. While ASTM B117 does not specify anything about the type of test specimen, dimensions, shape or exposure periods to be used for a specific product, it does describe the method for evaluating corrosion resistance within a salt spray test chamber. Typically, a substrate within the salt spray apparatus chamber is exposed to a salt spray for “X” number of hours, which loosely correlates with the amount of time that substrate is expected to be corrosion resistant during normal use. As a non-limiting examples, decorative parts such as the ones found in bathrooms will often get tested for an exposure between 24 and 96 hours, structural galvanized components used outdoors will often get an exposure of 8000-10,000 hours, while the standard for components within liftgate support struts are 480 hours.

Each of the coated support strut springs were exposed to a salt spray according to the ASTM B117 apparatus and method for 1000 hours. None of the substrates indicated any sign of corrosion.

### Example 9: Wear Resistance and Sound Dampening of Coated Substrates

The wear resistance and sound dampening properties of a support strut spring coated with either Formula 1, Formula 3, Formula 5, or Formula 6 was tested, by repeatedly cycling a lift gate having support struts assembled in part with the coated spring, at various atmospheric conditions—cold (−30° C.), ambient temperature, warm (65° C.), and warm (65° C.) at elevated humidity. In each atmospheric condition, the sound from the support struts was measured as the lift gate cycled between an open and closed position over 50,000 cycles. Wear resistance was evaluated by removing and disassembling the support struts and visually inspecting the coated spring. In each of the atmospheric conditions, the sound from the support struts never exceeded 1 sone (equivalent to a 1 kHz tone at 40 dB sound pressure level (SPL)), and visual inspection of the springs after their tests indicated no change in the appearance of their respective coatings.

We claim:

1. A composition formulated to provide anti-corrosive, sound dampening, and lubrication properties when applied to a metal or plastic substrate, particularly a spring disposed within the housing of an electromechanical strut configured to pivotably operate a rear hatch of a vehicle between an open position and a closed position, the composition comprising:
(a) at least one ketone, the at least one ketone selected from the group consisting of methyl amyl ketone, methyl aryl ketone, methyl ethyl ketone, methyl isopropyl ketone, methyl isobutyl ketone, and combinations thereof;
(b) a hydroxyl functional polyester; and
(c) at least one dry lubricant, the at least one dry lubricant comprising an inorganic solid selected from the group consisting of graphite, molybdenum disulfide, boron nitride, tungsten carbide, tungsten disulfide, and combinations thereof.

2. The composition according to claim 1, wherein the composition comprises:
(i) at least about 30% by weight, and up to about 50% by weight, of the at least one ketone;
(ii) at least about 10% by weight, and up to about 35% by weight, of the hydroxyl functional polyester; and
(iii) at least about 6% by weight, and up to about 25% by weight, of the at least one dry lubricant.

3. The composition according to claim 2, wherein the at least one dry lubricant comprises molybdenum disulfide, and the composition comprises at least about 6% by weight, and up to about 12% by weight, of molybdenum disulfide.

4. The composition according to claim 1, wherein the composition further comprises:
(a) a cross-linking agent; and
(b) a chemical catalyst, the chemical catalyst formulated to enhance the reactivity between the cross-linking agent and the hydroxyl functional polyester.

5. The composition according to claim 4, wherein the cross-linking agent is a methylated melamine monomer, and the chemical catalyst is an amine-blocked para-toluene sulfonic acid, wherein the mass ratio of the cross-linking agent to the chemical catalyst is in a range from about 8:1 up to about 12:1.

6. The composition according to claim 5, wherein the composition comprises at least about 1% by weight, and up to about 6% by weight, of the cross-linking agent, and at least about 0.1% by weight, and up to about 0.6% by weight, of the chemical catalyst.

7. The composition according to claim 1, wherein the at least one dry lubricant further comprises at least one fluoropolymer.

8. The composition according to claim 7, wherein the fluoropolymer comprises polytetrafluoroethylene (PTFE), and the composition comprises up to about 14% by weight of PTFE.

9. The composition according to claim 1, wherein the composition further comprises a co-solvent, the co-solvent selected from the group of short-chain alkyl alcohols and aromatic solvents consisting of: methanol, ethanol, propanol, isopropanol, benzene, toluene, xylene, mesitylene, and any combinations or isomers thereof.

10. The composition according to claim 9, wherein the composition comprises up to about 25% by weight of the co-solvent.

11. The composition according to claim 1, wherein the composition further comprises up to about 2% by weight of a colorant.

12. The composition according to claim 1, wherein the hydroxyl functional polyester has an acid value of less than about 10.

13. The composition according to claim 12, wherein the hydroxyl functional polyester has a hydroxyl number (mg KOH/gram of polyester) of at least about 250, and up to about 300.

14. The composition according to claim 1, wherein the at least one ketone comprises methyl isopropyl ketone, and optionally, methyl ethyl ketone.

15. The composition according to claim 14, wherein the composition comprises:
(a) at least about 9% by weight, and up to about 13% by weight, of methyl isopropyl ketone;
(b) at least about 20% by weight, and up to about 25% by weight, of methyl ethyl ketone;
(c) at least about 18% by weight, and up to about 32% by weight, of hydroxyl functional polyester;
(d) at least about 6% by weight, and up to about 12% by weight, of molybdenum disulfide;
(e) at least about 10% by weight, and up to about 14% by weight, of PTFE;
(f) at least about 1% by weight, and up to about 6% by weight, of methylated melamine monomer;
(g) at least about 0.1% by weight, and up to about 0.6% by weight, of amine-blocked para-toluene sulfonic acid; and
(h) at least 20% by weight, and up to about 25% by weight, of the co-solvent.

16. The composition according to claim 15, wherein the co-solvent comprises one or more solvents selected from the group consisting of ethanol, xylene, and combinations thereof.

17. The composition according to claim 14, wherein the composition comprises:
(a) at least about 40% by weight, and up to about 45% by weight, of methyl isopropyl ketone;
(b) at least about 18% by weight, and up to about 32% by weight, of hydroxyl functional polyester;
(c) at least about 6% by weight, and up to about 12% by weight, of molybdenum disulfide;
(d) at least about 10% by weight, and up to about 14% by weight, of PTFE;
(e) at least about 1% by weight, and up to about 6% by weight, of methylated melamine monomer;
(f) at least about 0.1% by weight, and up to about 0.6% by weight, of amine-blocked para-toluene sulfonic acid; and
(g) up to about 5% by weight, of the co-solvent.

18. The composition according to claim 17, wherein the co-solvent is selected from the group consisting of ethanol, xylene, and combinations thereof.

19. The composition according to claim 1, wherein the composition is disposed upon a metal or plastic substrate.
